(19) United States
(12) Patent Application Publication
(10) Pub. No.: US 2026/0030909 A1
(43) Pub. Date: Jan. 29, 2026

(54) SYSTEM AND METHOD FOR IDENTIFYING A CONTENT OF INTEREST IN DOCUMENTS

(71) Applicant: Antworks Pte Ltd, Singapore (SG)

(72) Inventors: Guha RAMASUBRAMANIAN, Bangalore (IN); Josmin JOSE, Kannur (IN)

(21) Appl. No.: 18/818,644

(22) Filed: Aug. 29, 2024

(30) Foreign Application Priority Data
Jul. 25, 2024 (IN) 202421056497

(51) Int. Cl. G06V 30/412; G06V 10/77; G06V 30/19; G06V 30/413

(52) U.S. Cl. CPC G06V 30/412; G06V 10/7715; G06V 30/19147; G06V 30/413

(57) ABSTRACT

The present invention discloses a system and method for identifying a content of interest in a document. The method includes receiving a plurality of training documents that comprise a plurality of field elements, estimating for each data element present within the training document, a weighted distance of the each data element from a field element that corresponds to the content of interest. A feature vector is created based on the weighted distance and a position of the each data element with respect to the field element. A set of feature vectors are developed for the plurality of field elements and is used for training a field identification model. The field identification model is applied on the document to identify a beginning position of the content of interest.

### FIELD

The present invention relates to content retrieval from data representational structures such as contract documents, emails and application forms, and more particularly to a system and method for identifying a content of interest in documents.

### BACKGROUND

Current systems for identifying relevant content within documents, function by analyzing the relative location of the sought content in relation to another predefined significant content. The traditional methods rely on predefined labels to identify and extract relevant information. Currently, several techniques are employed in prior art for detecting relevant content in documents, each with its advantages and limitations. One common technique is the template-based approach. The template-based approach is based on co-ordinate position and relies on predefined templates. This approach is effective when all documents follow the same predetermined structure, with standardized spatial locations in terms of coordinates (x, y).

This approach works well under conditions where information is presented in standardized forms and image sizes are uniform. However, this method fails when there are changes in presentation due to content wrapping to the next line or minor format updates. Additionally, issues arise when image captures are not of the same pixel size, or when there is image skewing or rotation. Although existing techniques address these issues by calculating standardized coordinates relative to multiple key anchor content, this approach becomes cumbersome. Another method to handle template variations is to create multiple templates and use initial logic to determine the appropriate template. However, this method is not scalable, as the number of representational templates increases. For HTML pages, while extraction is linked to specified tags, the process is highly dependent on the page-hierarchy structure, which can change without notice, leading to extraction failures.

Another technique is the label-based heuristic approach. In this method, content of interest is referenced by a defined set of labels, and the content is searched in the vicinity of these labels. This method faces several challenges. Multiple labels may represent the same concept, requiring aggregation of all possible labels without a structured way to prioritize them, resulting in numerous candidates representing the content of interest. Text denoting labels may also appear in irrelevant areas, leading to false positives. Additionally, digitization issues, such as converting images into textual content with wrong conversion due to poor quality images and pixelation, can render this approach ineffective. Fuzzy searches used to handle the above digitization issues, often pull in more text labels that fall within the fuzzy text search window, increasing false positives. Finally, the feedback loop for this method is limited to adding more labels, which restricts the quality improvement of the extraction process over time.

A more advanced technique involves leveraging sophisticated transformer models for content detection. In this approach, the content from relevant pages is aggregated and sent to a transformer model, including Generative AI models like OpenAI, Claude, or Llama. These models can be either open-source or proprietary. However, this approach presents several challenges, including the lack of transparency and explainability due to the black-box nature of such models, limited ability to tweak the model through available parameters, and concerns around model drift. Furthermore, there are significant computational costs associated with hosting and managing large models either on-premises or on the cloud. Data privacy is another concern, especially if sensitive data is sent outside enterprise boundaries. Performance challenges also arise when scaling to large volumes on the internet.

To overcome these challenges, a novel method and system for identifying content of interest in documents is proposed. This present disclosure aims to provide a more robust, scalable, and efficient solution for content detection, addressing the limitations of existing techniques.

### SUMMARY

The following summary is illustrative only and is not intended to be in any way, to be limiting. In addition to the illustrative aspects, example embodiments, and features described, further aspects, example embodiments, and features will become apparent by reference to the drawings and the following detailed description.

Briefly, according to an example embodiment, a system for identifying a content of interest from a corpus of data structures such as documents is disclosed. The system includes at least one processor, a memory storing instructions that when executed by at least one processor cause the system to obtain the corpus of documents, where each data structure contains the content of interest, and identify the content of interest within the corpus of documents. Examples of documents can include content-rich textual documents such as insurance documents, medical records, company information, and the like, or image documents having a combination of image and text. The content of interest to be identified can be a textual content, an image content or a combination of both. In an example, the corpus of documents can be a set of insurance policy documents, and the content of interest can be related to limits of liability provided within each document.

According to an example embodiment, the system includes an input module configured to obtain the corpus of documents, from which the content of interest is to be identified. Typically, each document contains the content of interest. The input module further receives a plurality of training documents, where each training document includes one or more textual content, image content or a combination thereof, that comprises a plurality of field elements, where one field element is the content of interest. A field element can be textual data, image data or a combination of both. The system further includes a training module coupled to the input module and configured to scan through each page of a training document for determining a frequency of occurrence of each data element within the training document. In an embodiment, the training document can be sectioned into a plurality of zones, and the training module can determine one or more zones in which the each data element occurs.

The training module is further configured to identify one or more generic and domain specific patterns in the training document and replace each of the one or more generic, and domain-specific patterns with a unique replacement element. Further, the training module is configured to eliminate one or more predefined data elements from the training document. Examples of a predefined data element include a pronoun, a proposition, a conjunction, or a data element identified as least relevant in retrieval of the content of interest. Further, the training module eliminates from the training document one or more data elements that have a frequency of occurrence lesser than a predetermined threshold value. The training module develops a feature matrix comprising a frequency of occurrence of each remaining data element in each zone of the training document. The training module provides the feature matrix as an input to train the context window identification model. The context window identification model is used by the training module to select the context window surrounding the field element. A plurality of parameters as defined for the field element are also used by the training module in selecting the context window. Example of plurality of parameters include but are not limited to a data type associated with each field element, a text alignment of the field element, text spacing within the field element, fonts of the field element, location parameters and context window parameters defined for each field element.

Further, within the context window, the training module estimates for each data element present within the context window, a weighted distance from the field element, where the weighted distance and a position of each data element is used to create a feature vector. In an embodiment, the weighted distance of each data element from the content of interest is computed by determining a distance and direction along a horizontal and vertical axis of the each data element from the content of interest and applying a weight factor associated with each of the horizontal and vertical direction.

Similarly, a set of feature vectors for the plurality of field elements present in the plurality of training documents is created. The set of feature vectors is provided as an input to train a field identification module. When the training of the context identification model and the field element identification model on the plurality of training documents is completed, then a prediction module coupled to the training module, uses the context identification model and the field element identification model to identify the content of interest in a document. Typically, the prediction module applies the context window identification model to each document to identify one or more candidate context windows that contain the content of interest. Further, the prediction module applies the field element identification model on the one or more candidate context windows to identify a beginning position of the content of interest within a candidate context window, where the beginning position is used to retrieve the content of interest from each document.

The system further includes a validation module coupled to the training module, where the validation module is configured to validate the retrieved content of interest based on the plurality of parameters defined for the field element and provide the retrieved content of interest on a user interface. In case the retrieved content of interest fails to match with the content of interest, then the validation fails, and the validation module determines a difference between the content of interest and the retrieved content of interest. The validation module further, adjusts the plurality of parameters, and the weight factor associated with each direction based on the difference determined between the content of interest and the retrieved content of interest, and retrain the context window identification model and the field element identification model on the document with the adjusted plurality of parameters and the adjusted weight factor.

According to another embodiment, a method for identifying a content of interest in a document is disclosed. The method includes obtaining the document containing the content of interest, receiving a plurality of training documents, where each training document includes one or more textual and image content that comprises a plurality of field elements, and where one field element is the content of interest. The method further includes, selecting a context window surrounding a field element in a training document based on a plurality of parameters defined for the field element, and by applying a context window identification model to the training document; estimating for each data element present within the context window of the training document a weighted distance of the each data element from the field element, wherein the weighted distance and a position of the each data element with respect to the field element is used to create a feature vector. The method further includes, providing a set of feature vectors developed for the plurality of field elements across the plurality of training documents as an input, in training a field element identification model. Furthermore, the method includes applying the context window identification model to the document to identify one or more candidate context windows that contain the content of interest and applying the field element identification model on the one or more candidate context windows to identify a beginning position of the content of interest within a candidate context window.

According to another embodiment, a method for identifying a content of interest in a document is disclosed. The method includes, obtaining the document containing the content of interest; receiving a plurality of training documents, wherein each training document includes one or more textual and image content that comprises a plurality of field elements, wherein one field element corresponds to the content of interest; estimating for each data element present within the training document a weighted distance of the each data element from the field element, wherein the weighted distance and a position of the each data element with respect to the field element is used to create a feature vector; providing a set of feature vectors developed for the plurality of field elements across the plurality of training documents as an input, in training a field element identification model; and identifying a beginning position of the content of interest by applying the field element identification model on the document.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram of a system configured to identify a content of interest in a corpus of documents, according to an example embodiment;

FIG. 2A is a flow diagram illustrating training of a context window identification model by a training module of the system of FIG. 1, according to an embodiment;

FIG. 2B is a flow diagram illustration training of a field element identification model by the training module of the system of FIG. 1, according to an example embodiment;

FIG. 3 is a flow diagram illustrating identification of the content of interest in a document based on the trained context identification model and the trained field element identification model of the system of FIG. 1, according to an example embodiment;

FIG. 4A illustrates an example training document on which the context window identification model and the field element identification model of the system of FIG. 1 is trained, according to an example embodiment;

FIG. 4B illustrates the example training document of FIG. 4A, in which one or more generic and domain specific patterns are replaced with a unique replacement element, and predefined elements are eliminated, according to an example embodiment;

FIG. 4C illustrates a feature matrix developed for a field element of the training document of FIG. 4A used for training the context window identification model, according to an example embodiment;

FIG. 4D illustrates a feature vector created for the field element within a context window of the training document of FIG. 4A and used for training the field element identification model, according to an example embodiment;

FIG. 5 illustrates a flowchart depicting a method of for identifying content of interest in a document, according to an example embodiment;

FIG. 6 illustrates a flowchart depicting a method for selecting a context window for a field element in a training document, according to an example embodiment;

FIG. 7 illustrates a flowchart depicting a method of for identifying content of interest in a document, according to an example embodiment; and

FIG. 8 is a block diagram of an embodiment of a computing device in which the modules of the system of FIG. 1, described herein, are implemented.

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein.

Accordingly, while example embodiments are capable of various modifications and alternative forms, example embodiments are shown by way of example in the drawings and will herein be described in detail. It should be understood, however, that there is no intent to limit example embodiments to the particular forms disclosed. On the contrary, example embodiments are to cover all modifications, equivalents, and alternatives thereof. Similarly, like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figure. The processes may correspond to methods, functions, procedures, subroutines, subprograms, etc.

Specific structural and functional details disclosed herein are merely representative for purposes of describing example embodiments. Inventive concepts may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any, and all combinations of one or more of the associated listed items. The phrase “at least one of” has the same meaning as “and/or”.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of inventive concepts.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skills in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in ‘addition to the orientation depicted in the figures. For example, if the device in the figures is turned over, elements described as “below”, or “beneath” other elements or features would then be oriented “above” the other elements or features. Thus, term such as “below” may encompass both an orientation of above and below. The device may be otherwise oriented (rotated 90 degrees or at other orientations) and the spatially relative descriptors used herein are interpreted accordingly.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

At least one example embodiment is generally directed to techniques for identifying a content of interest in a corpus of documents. In particular, the embodiments disclose techniques relating to training machine learning models on a plurality of documents for identifying a plurality of content. The machine learning models include a context identification model and a field element identification model trained to identify the content of interest by using positional data within a context window. Detailed working is explained hereinbelow with reference to the figures.

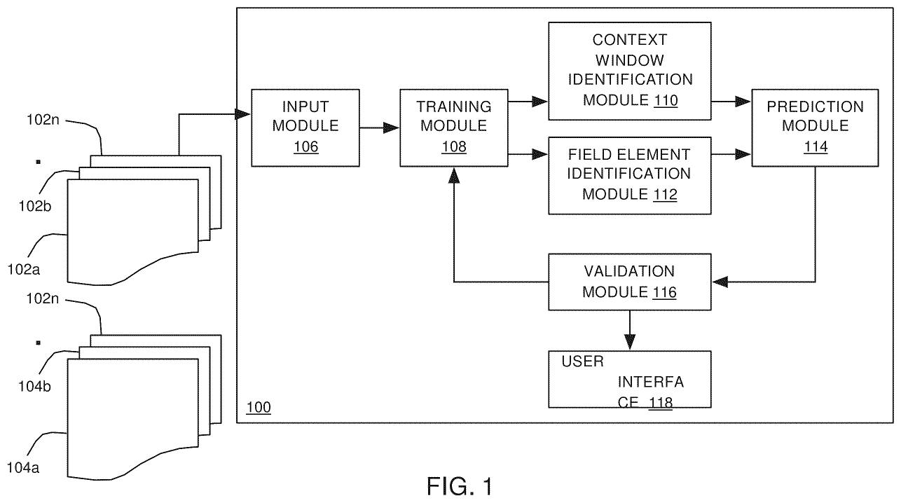

FIG. 1 illustrates a system (100) for identifying a content of interest in a corpus of documents (102a-102n). The system (100) is trained on a plurality of training documents (104a-104n). The system (100) includes an input module (106), a training module (108), a context window identification model (110), a field element identification model (112), a prediction module (114), a validation module (116), and a user interface (118). The input module (106) is configured to obtain the corpus of document (102a-102n), where each document contains the content of interest. For example, the corpus of documents 102a-102n), could be a set of insurance policy documents and the content of interest could be “limits of liability” of an insurance contract. In order to identify the content of interest, the training module (108), coupled to the input module (106), is configured to train the context window identification model (110) and the field element identification model (112), based on data elements and positioning of field elements present within the plurality of training documents (104a-104b). Typically, a training document (e.g. 104a) can contain content comprising textual content, image content and/or a combination thereof, and the content can be identified into a plurality of field elements. An instance of a field element can be a word, label, an image, a collection of words that appear together often, a phrase and the like. For example, “Name, “Name of Insured”, “Insured for” are words or phrases that point to a name of a person for whom an insurance policy is drawn, and can be identified with a field element “Name”.

During the training, the training module (108) scans through each page of a training document (e.g. 104a) to determine a frequency of occurrence of each data element within the training document (104a) and one or more zones in which the each data element occurs within the training document (104a). Typically, each page of the training document (104a), can be sectioned into a plurality of zones and a data element such as a label “Name of Insured:” can be found in one or more zones of the training document (104a). For example, if the training document (104a) is an insurance policy document and is divided into four zones, then the field element or the data element “Name of Insured:” can be mostly found in the top left zone. In case, the data element “Name of Insured” occurs mostly in the top left zone of all the remaining training documents (104b-104n), then a context window for such data element can be constructed in the top left zone of the training document (104a).

Additionally, before using the training document (104a) for training of the context window identification model (110), pre-processing operations are performed on the training document (104a). Examples of pre-processing operations include identifying one or more generic and domain specific patterns in the training document (104a) and replacing each of the one or more generic and domain specific patterns with a unique replacement element. For example, the field value of the data element ‘Name of Insured” would typically be the name of person or a company that is being insured, and the field value would vary across the training documents (104a-104n). As names are usually alphanumeric in nature, such generic patterns can be replaced with a unique identifier (also referred to as a unique replacement element) such as #alphanumeric_name. Another example could be the logo of the insurance company that is present anywhere in the document. Such logos can be identified and replaced with an identifier such as “#logo_company”. Further, the training document (e.g. 104a) can have one or more predefined elements such as pronoun, a proposition, a conjunction, or any data element identified as least relevant in retrieval of the content of interest and a combination thereof. For example, words like “is”, “and”, from”, “to” and the like are deleted from the training document (e.g. 104a). Further, data elements that have a frequency of occurrence less than a threshold value are eliminated from the training document.

From the remaining data elements existing in the training document (e.g. 104a) a feature matrix is developed. The feature matrix basically contains a frequency of occurrence of each remaining data element in each zone of the training document (e.g. 104a). The feature matrix is then provided as an input for training the context window identification model (110). By using the context window identification model (110) that is trained on the feature matrix, a context window surrounding a field element, is selected. Further, a plurality of parameters defined for the field element is used for the selection of the context window. In an embodiment, the plurality of parameters, comprises parameters defined for a data type associated with each filed element, a text alignment of the field element, a text spacing within the field element, fonts of the field element, location parameters and context window parameters defined for the each field element. For example, if in the plurality of training documents (104a-104n), a field element such as “Name of Insured” is found usually on a top-left corner of a first page in each of the training documents, then the text alignment, zone of the page, of the field element “Name of Insured” are saved as parameters associated with the field element, and are referred to while selecting a context window surrounding the field element.

Once the context window of the field element is selected, then for each data element, present within the context window, a weighted distance of the each data element from the field element is estimated. The weighted distance and a position of the each data element with respect to the field element is used to create a feature vector for the field element. Similarly, a set of feature vectors is developed for the plurality of field elements present across the plurality of training documents, and this set of feature vectors is provided as an input to train the field element identification model (112). Once the context window identification model (110) and the field element identification model (112) are trained on each of the training documents (104a-104n), then the prediction module (114) is tested on a document (e.g. 102a) selected from the corpus of documents (102a-102n). Testing includes basically whether the prediction module (114) is able to identify the content of interest within the document (e.g. 102a) correctly. In order to identify the content of interest within the document (e.g. 102a), the prediction module (114) applies the context window identification model (110) to the each document (e.g. 102a) to identify one or more candidate context windows, that contain the content of interest. Further, the prediction module (114) identifies a beginning position of the content of interest within a candidate context window by applying the field element identification model (112) on the one or more candidate context windows, where the beginning position is used to retrieve the content of interest from the each document (e.g. 102a).

Once the beginning position is identified, the content of interest is then read or retrieved from the document (102a) and is validated by the validation module (114) against an actual content of interest present in the document. In an example, the validation can be based on the plurality of parameters defined for the field element. If the plurality of parameters includes a data type of numeric for the content of interest, but the retrieved content of interest is alphanumeric, then the validation of the retrieved content of interest fails. The retrieved content of interest can be provided on the user interface (118), for a user to visualize. The validation module (114) determines a difference between the content of interest and the retrieved content of interest, when the retrieved content of interest fails to validate. Further, the validation module (114) adjusts the plurality of parameters, and the weight factor associated with the each direction based on the difference determined between the content of interest and the retrieved content of interest. Furthermore, the validation module (114) retrains the context window identification model (110) and the field element identification model (112) on the document with the adjusted plurality of parameters and the adjusted weight factor associated with the each direction. The retrained models are now more equipped to handle a document having a similar configuration as the document (102a) and can identify the content of interest accurately.

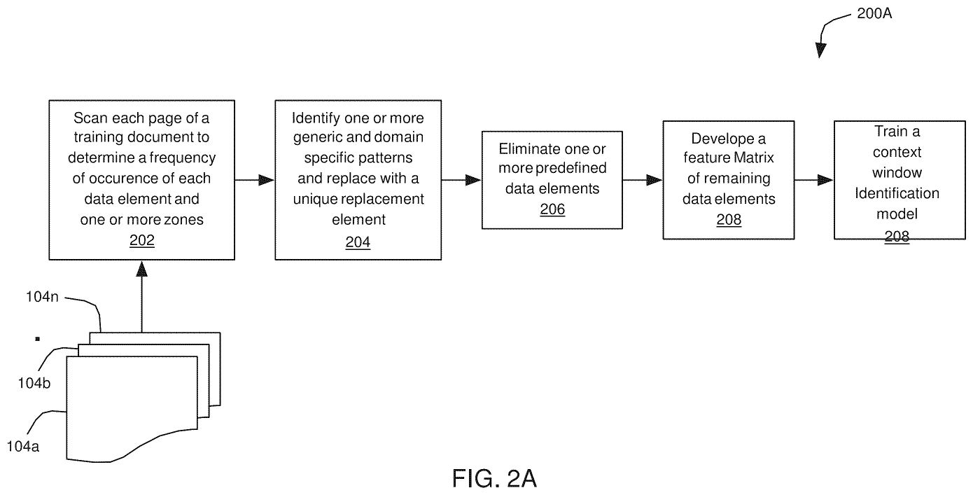

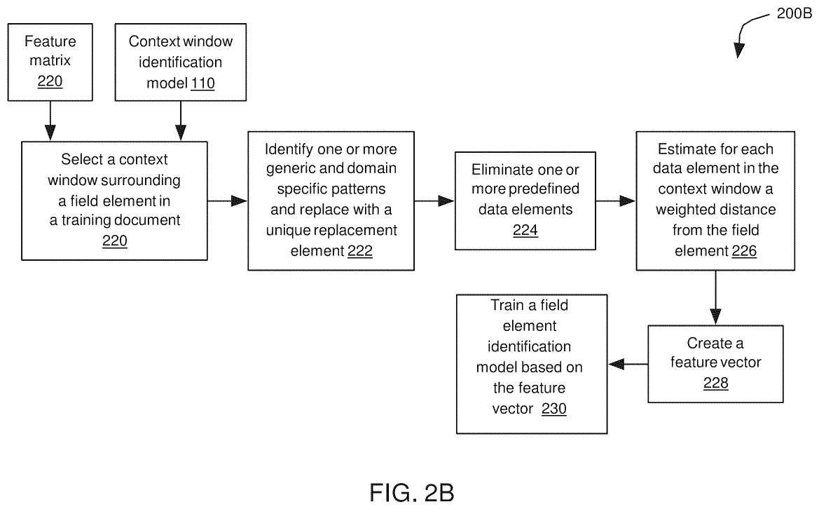

FIG. 2A is a flow diagram (200A), illustrating training of the context window identification model (110) by a training module (108) of the system (100) of FIG. 1, according to an embodiment. As shown, the plurality of training documents (104a-104n) is provided as input to the training module (108). At 202, each page of a training document (e.g. 102a) is scanned to determine a frequency of occurrence of each data element and one or more zones within the page. A frequency of occurrence of each data element in a zone is also determined in this step. At 204, one or more generic and domain specific patterns are identified within the training document (e.g. 102a) and replaced with a unique replacement. At 206, one or more predefined data elements, also referred to as stop words, are eliminated or deleted from the training document (102a). At 208, a feature matrix is developed of the remaining data elements, and at 210, a context window identification model (110) is trained based on the feature matrix.

FIG. 2B is a flow diagram (200B), illustrating training of the field element identification model (112), by the training module (108) of FIG. 1. A feature matrix (212) is provided as an input to the context window identification model (110), and at 220 a context window is selected surrounding a field element, in a training document. At 222, one or more generic and domain specific patterns within the context window are identified and replaced with a unique replacement element. At 224, one or more predefined data elements are eliminated. At 226 for each data element in the context window a weighted distance is estimated from the field element. At 228, a feature vector is created. At 230 a field element identification model (112) is trained based on the feature vector.

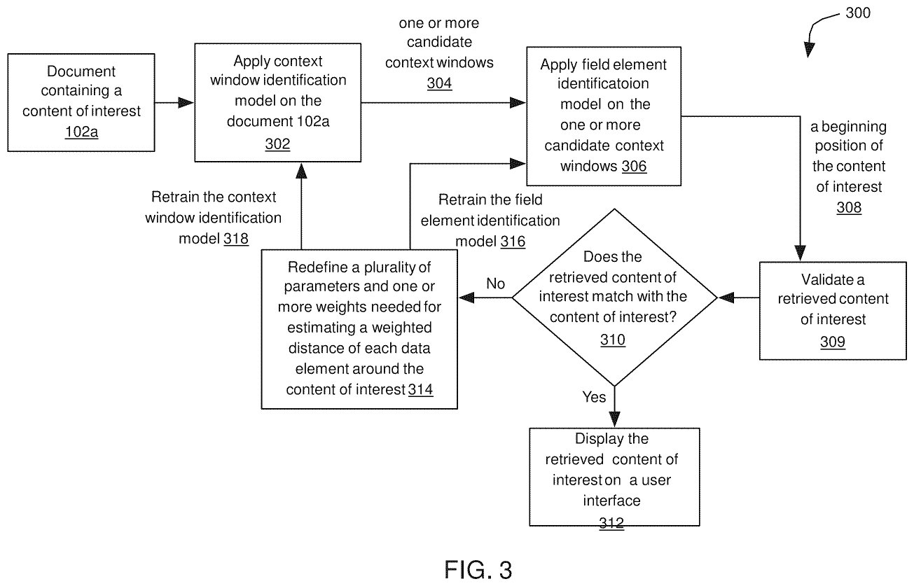

FIG. 3 is a flow diagram (300) illustrating identification of a content of interest in the document (102a) based on the trained context identification model (110) (as described in FIG. 2A) and the trained field element identification model (112) (as described in FIG. 2B) of the system (100). The document (102a) containing the content of interest is provided as an input to the context window identification model (110). At 302, the context window identification model (110) is applied on the document (102a), to provide as an output one or more candidate context windows (304) in which the content of interest can be stored. At 306, the field element identification model (112) is applied on the one or more candidate context windows to obtain the beginning position of the content of interest (308). At 309, the retrieved content of interest is validated. At 310, a determination of whether retrieved content of interest matches with content of interest is made. Incase the retrieved content of interest matches with the content of interest, then the retrieved content of interest is displayed on the user interface, at 312. Alternatively, if the retrieved content of interest fails to match with the content of interest that is present in the document (102a), then at 314, a plurality of parameters and a weight factor used for estimating weighted distance of each data element around the content of interest is redefined or adjusted, such that the retrieved content of interest matches with the content of interest. Further, at 316 with the adjusted plurality of parameters and the adjusted weight factor, the field element identification model (112) is retrained by the training module (108). At step 306 the retrained field element identification model (112) is applied again on the document (102a) at step 306, for identifying another beginning position of the content of interest. Similarly, at 318, the context window identification model (110) is retrained on the adjusted plurality of parameters and the adjusted weight factor. The retrained context window identification model (110) is then reapplied to the document (102a) to identify one or more candidate context windows (304). The training of the context window identification model (110) and the field element identification model (112) are explained in further detail with respect to an example training document (104a).

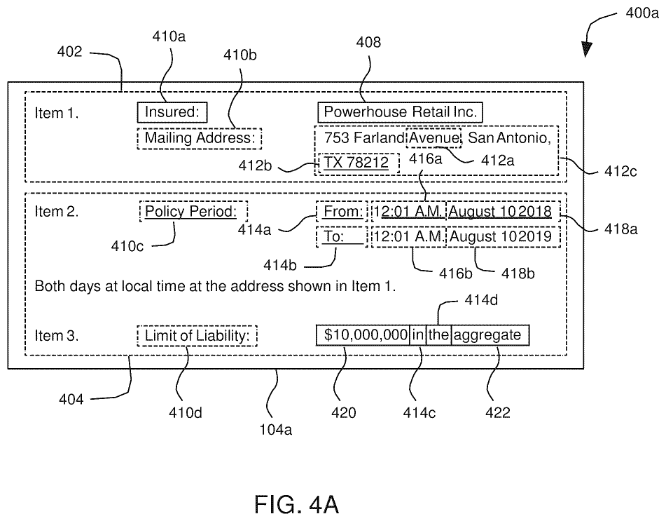

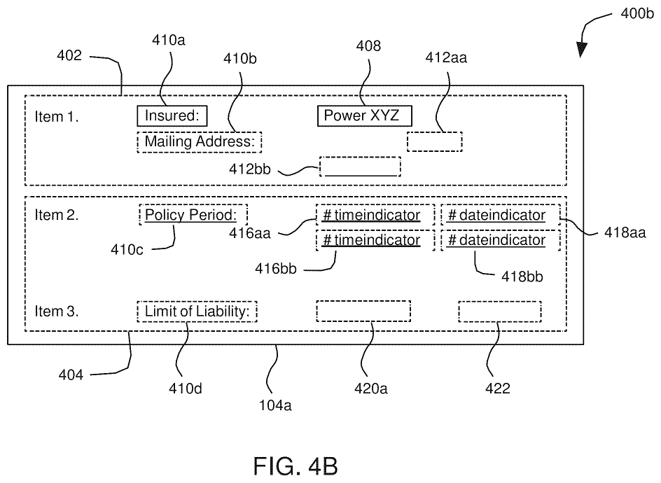

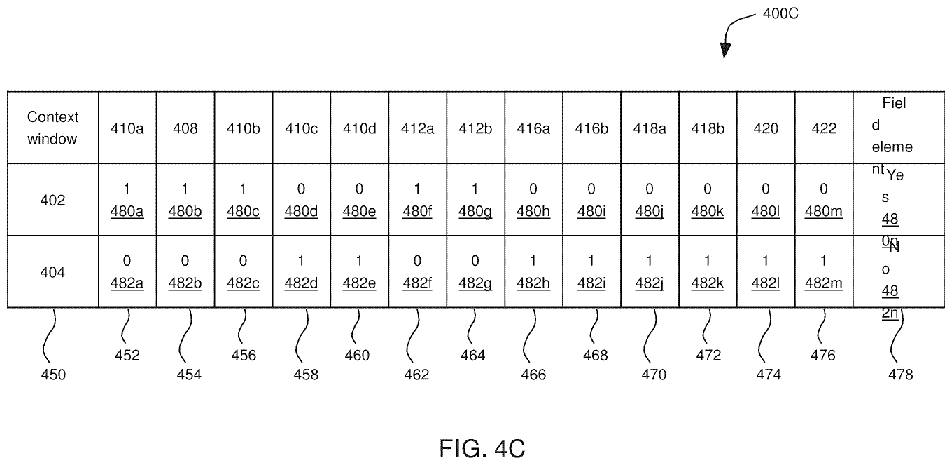

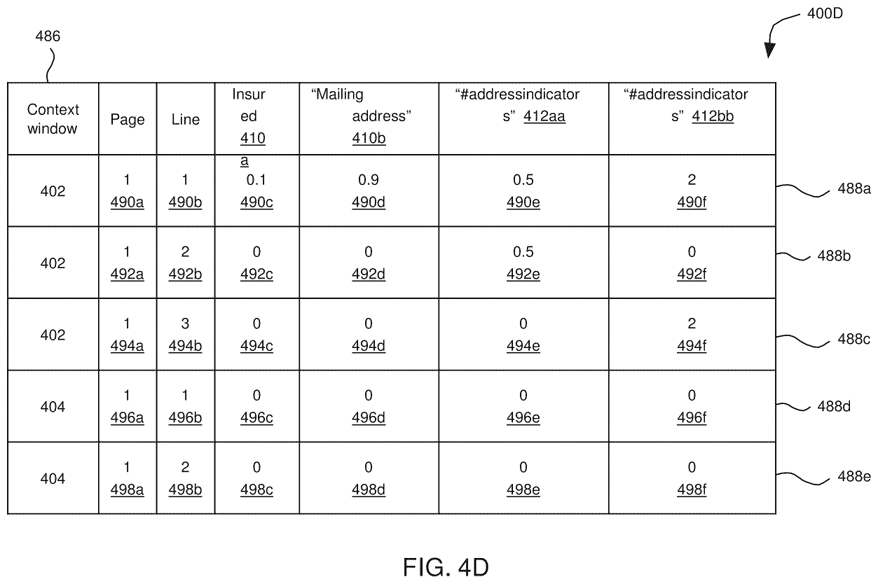

FIG. 4A illustrates a first page of the training document (104a) on which the context window identification model (110) and the field element identification model (112) of the system (100) are trained, according to an example embodiment. As shown, the first page training document (104a) is divided into two zones (402) and (404). It is noted that, though the first page is divided into two zones, division into multiple equal or unequal zones is also envisaged by this disclosure. The zone (402) includes a field element “Insured” (410a) associated with a field element “power XYZ” (408), which is a field value of the field element (410a). The zone (402) further includes a field element “Mailing Address” (410b) that has a field value (412aa). The field value “123, Syra Avenue, San Antonia, TX 78212” (412bb). Further, the zone (404) contains a field element “Policy Period: (410c), having a field value of “From: (414a)”, “12:01 AM (416a)”, “Aug. 10, 2018”, “To” (414db, “12:01 AM” (416b) and “Aug. 10, 2019” (418b). Furthermore, the zone (404) also contains another field element “Limit of Liability” (410d), and field value “$10,000,000” (410), “in” (414c) “the” (414d), and “aggregate” (422). In order to create the feature matrix and feature vector for training the context window identification model (110) and the field element identification model (112) the operations followed are illustrated in FIGS. 4B-4D.

FIG. 4B illustrates the example training document (104a) of FIG. 4A, in which one or more generic and domain specific patterns are replaced with a unique replacement element, and predefined elements are eliminated. For example, the word “Avenue” (412a) can be indicated as a word that usually occurs in addresses, and hence is replaced with an unique replacement element “#addressindicator” (412aa), and the pin code “TX 78212” (412b) is replaced with “#addressindicator” (412bb) as well, to indicate that these two words or phrases “Avenue” and “TX 78212” that are present in two successive lines form an address element (412c). Indication of words with such replacement elements, help in processing the document better. Similarly, the field value “12:01 AM (416a)” is replaced with a “#timeindicator” (416aa), “12:01 AM” (416b) is replaced with “#timeindicator” (416bb), date element “Aug. 10, 2018” (418a) is replaced with “#dateindicator” (418aa), and “Aug. 10, 2019” is replaced with “#dateindicator” (418bb). Similarly, “$10,000,000” (420) is replaced with “#currencyindicator” (420a). Further, one or more predefined elements such as “From” (414a), “To” (414b″ “in” (414c), “the” (414d), are eliminated from the document (104a). Further, the frequency of occurrence of each of the remaining data elements such as 410a, 410b, replacement elements 412aa, 412bb, 416aa, 416bb, 418aa, 418bb, 420a and 422 are recorded into a feature matrix as shown in FIG. 4C.

FIG. 4C illustrates a feature matrix (400C) developed for a field element (408) of the training document (104a) used for training the context window identification model (110), according to an example embodiment. In this example, zone (402) is selected as a context window surrounding the field element (408), and zone (404) is identified as another context window. Further, as shown, a number of times a data element occurs within a context window is provided in the feature matrix (400c). For example, (410a) occurs once and hence a numeral “1” is assigned to the block (480a). Further, the field element (408) occurs once, and hence a numeral “1” is assigned to the block (480b). Similarly, as data element (410d) does not occur in the context window (402) a number of “0” is assigned to block (480e). The column “field element” (478) is assigned a value of “Yes” or “No” depending on whether the content of interest or the “field element” (408) for which the feature matrix (400c) is constructed, is present within the respective context window. Hence, in block (480n), a value of “Yes” is assigned and to (482n) a value of “No”, as the field element (408) is present in the context window (402) and not in the context window (404). By using the feature matrix (400C) a feature vector is developed as explained further with reference to FIG. 4D.

FIG. 4D illustrates a feature vector (400D) created for the field element (408) within the context window (402) of the training document (104a) and is used for training the field element identification model (112), according to an example embodiment. The feature vector (400D) comprises of vectors (488a-488c) for the context window (402). Firstly, a set of nucleus data elements for the field element (408) are identified as “Insured” (410a), “mailing address” (410b), “#addressindicator” (412aa), and “#addressindicator” (412bb). In an example, a weight factor assigned to each direction from the field element (408) towards the set of nucleus data elements, can be 0.1 to a left direction, 04 to a right direction, 02 to a top direction, and 0.5 to a bottom direction. Based on the weight factor assigned to the each direction, and a position of each nucleus data element (410a, 410b, 412aa, and 412bb) with respect to the field element (408), a weighted distance of the each nucleus data element (410a, 410b, 412aa, and 412bb) within the context window (402) from the field element (408) is estimated. In an embodiment, the weighted distance can be calculated by applying the following criteria: ((number of right/left shifts from selected content to the selected nucleus)2*(weight factor associated with right/left direction respectively))+((number of top/bottom shifts from selected content to the selected nucleus) 2*(weight factor associated with right/left direction respectively))

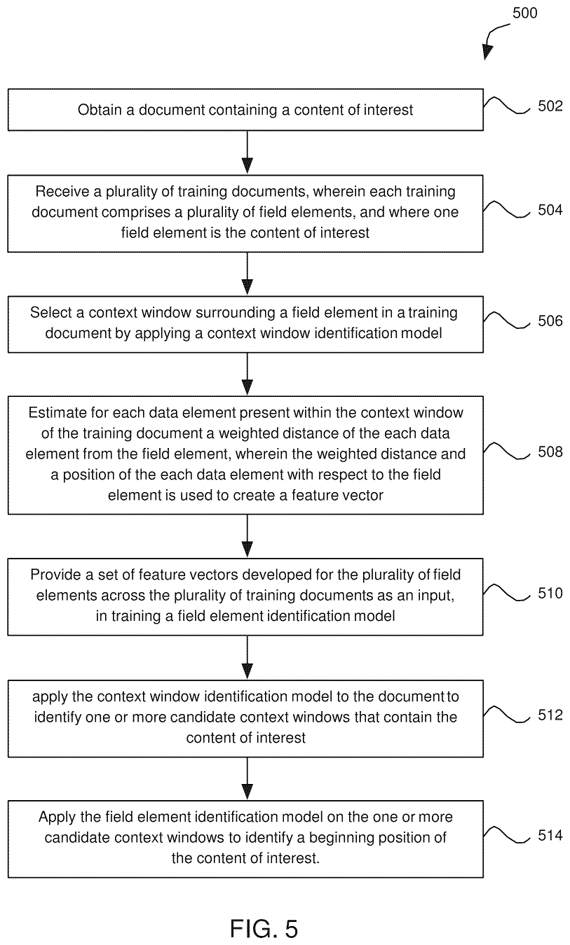

For example, a weighted distance of the field element “Insured” (410a) from the field element (408) can be calculated as: (1 left shift) \hat{ }2*(0.1)+(0)\hat{ }2*0=0.1. This weighted distance is populated in the feature vector (400D) in block (490c). Further, a weighted distance of the field element also referred to as the nucleus data element “Mailing Address” (410b) from the field element (408) can be calculated as: (2 left shifts)\hat{ }2*(0.1)+(1 bottom shift)\hat{ }2*(0.5)=2\hat{ }2*0.1+1*0.5=4*01+0.5=0.9. This weighted distance of 0.9 for the nucleus data element “Mailing address” (410b) is populated into block (490d) of the feature vector (400D). Similarly, a weighted distance of“#addressindicator” (412aa) is (1)\hat{ }2*0.5=0.5 is populated into block (490e) and a weighted distance of “#addressindicator” (412bb) is (2)\hat{ }2*0.5=2 is populated into block (490f). The weighted distances as populated into blocks (490a-490f) of (488a) are used to train the field element identification model (112). Similarly, vectors (488b-d) are used to train the field element identification model (112). A further explanation of a method followed in training the models (110) and (112), and utilizing the trained models to predict or identify a content of interest in a new document is further explained with respect to flowcharts in FIGS. 5-7.

FIG. 5 illustrates a flowchart 500 depicting a method of identifying content of interest in a document, according to an example embodiment. At 502, a document (or a test document) containing the content of interest is obtained. Examples of the document can include admission forms, health records, insurance policies, photographs, catalogue and the like. The document can contain textual content, image content or a combination of both. The content of interest could be a text content, an image content or a combination of both.

At 504, a plurality of training documents is received, where each training document comprises a plurality of field elements, and where one field element is the content of interest. Basically, the method can identify the content of interest and a location of the content of interest in the test document, only if a machine-learning model is trained on one or more documents that contain the content of interest and that has a similar layout or configuration as the test document.

At 506, a context window is selected surrounding a field element in a training document, by applying a context window identification model. Basically, a plurality of parameters can be defined for the field element that is the content of interest, such as a zone and page of a training document in which the content of interest is usually present, a font size used for displaying the content of interest, a data type and the like. The context window identification model is basically configured to determine a size of the context window based on the plurality of parameters defined for the field element and based on one or more data elements and a position of each data element around the content of interest, across the plurality of training documents.

At 508, for the each data element present within the context window of the training document, a weighted distance for the each data element is estimated from the field element, where the weighted distance and a position of the each data element with respect to the field element is used to create a feature vector. Similarly, a set of feature vectors are developed for the plurality of field elements across the plurality of training documents.

At 510, a set of feature vectors is provided as an input in training a field element identification model. Basically, the set of feature vectors capture the various layouts and configurations of the plurality of field elements, in the plurality of training documents. Hence, the field element identification model gets trained to identify any field element form the plurality of field elements, when a new document is presented to it.

At 512, once the training of the models is completed, the test document is presented to the context window identification model which identifies one or more candidate windows that contain the content of interest.

At 514, the field element identification model is applied to the one or more candidate context windows, and a calculation of weighted distances of each data element within a candidate context window to the field element, is performed to identify a beginning position of the content of interest. Once the beginning position is obtained, based on the data length, and type of the data of the content of interest as retrieved from the plurality of parameters defined for such field element, the content of interest can be retrieved.

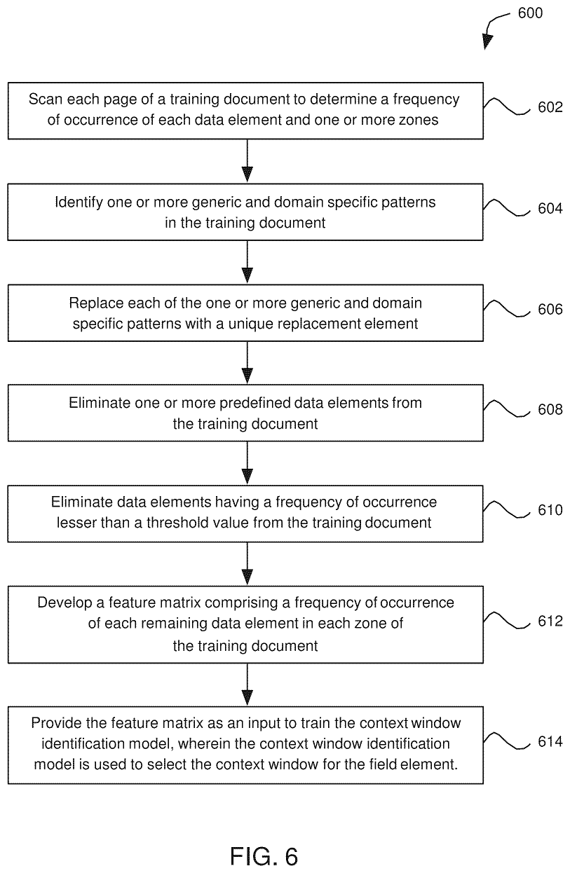

FIG. 6 illustrates a flowchart 600 depicting a method for selecting a context window for a field element in a training document, according to an example embodiment. At 602, each page of a training document is scanned to determine a frequency of occurrence of each data element, one or more zones into which the each page is divided into and a frequency of occurrence of the each data element in each zone of the training document.

At 604, one or more generic and domain specific patterns are identified in the training document. Generally, field values that keep varying across training documents, can be tagged and replaced with generic identifiers, so that the model is trained to recognize the patterns and focus on the field elements to identify relevant content.

At 606, each of the one or more generic and domain specific patterns are replaced with a unique replacement element. Replacement of generic and specific domain patterns helps with quicker and accurate analysis of the training documents. It also helps classify the data elements into fixed patterns and train the context window identification model with higher accuracy.

At 608, one or more predefined data elements are eliminated from the training document. Basically, pronouns, conjunctions, prepositions, company logos, and other such data elements which have little or no relevance to identification of the content of interest are removed from the training document.

At 610, data elements having a frequency of occurrence lesser than a threshold value are eliminated from the training document. Basically, in FIG. 4A, the data element “Aggregate” 422 has a very low frequency of 1 in one training document (104a) and may not be present in other training documents (104b-14n). Hence, such words that have a low significance by virtue of having less frequency and less impact on the content of interest, are eliminated from the training documents (104a-104n), and from any test document as well.

At 612, a feature matrix, is provided as an input to train the context window identification mode, where the context window identification model is used to select the context window for the field element. Accurate identification of the context window, helps in faster retrieval and accurate retrieval of the content of interest from a test document. It also helps in reducing usage of processing resources of the system in identifying a content within a context window, in comparison to identifying content within the whole test document.

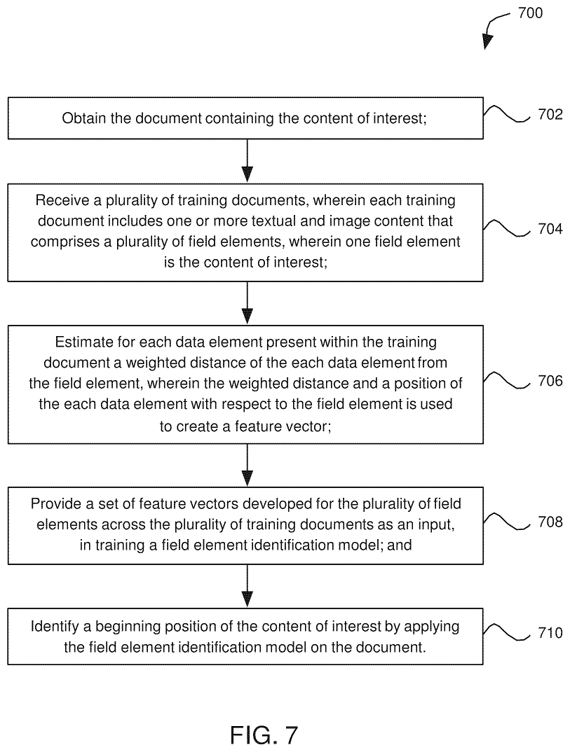

FIG. 7 illustrates a flowchart 700 depicting method for identifying content of interest in a document, according to an example embodiment. In this embodiment, the content of interest can be identified without use of the context window identification model. At 702, the document containing the content of interest is obtained or received as an input.

At 704, a plurality of training documents, each training document including one or more textual and image content that comprises a plurality of field elements, is provided as an input. Typically, one field element is the content of interest.

At 706, for each data element present within the each training document, a weighted distance of each data element from the field element is estimated. The weighted distance and a position of the each data element with respect to the field element is used to create a feature vector.

At 708, a set of feature vectors developed for the plurality of field elements across the plurality of training documents, is provided as an input in training a field element identification model. In fact, the training document is analysed as a whole, and the positional and content of each data element with respect to the field element is inputted into the feature vector for training the field element identification model. Basically, the method illustrated in flowchart 700, does not use a context window identification model.

At 710, a beginning position of the content of interest is identified by applying the field element identification model on the document. The content of interest is then retrieved from the beginning position.

The advantages of the disclosed method and system are numerous. Firstly, the disclosed method significantly enhances the training of agents involved in manual or augmented extraction processes by utilizing algorithm-based training materials. This ensures that agents receive precise, targeted training, improving their proficiency and accuracy, and enabling them to handle complex extraction tasks more efficiently and reliably.

Secondly, the system optimizes the design of forms and documents to align with user intuition, thereby reducing errors. By understanding and integrating the user's mental model during form completion, the design ensures that related fields are logically and spatially organized. This thoughtful arrangement facilitates user action and minimizes errors, enhancing the overall user experience and accuracy of data entry.

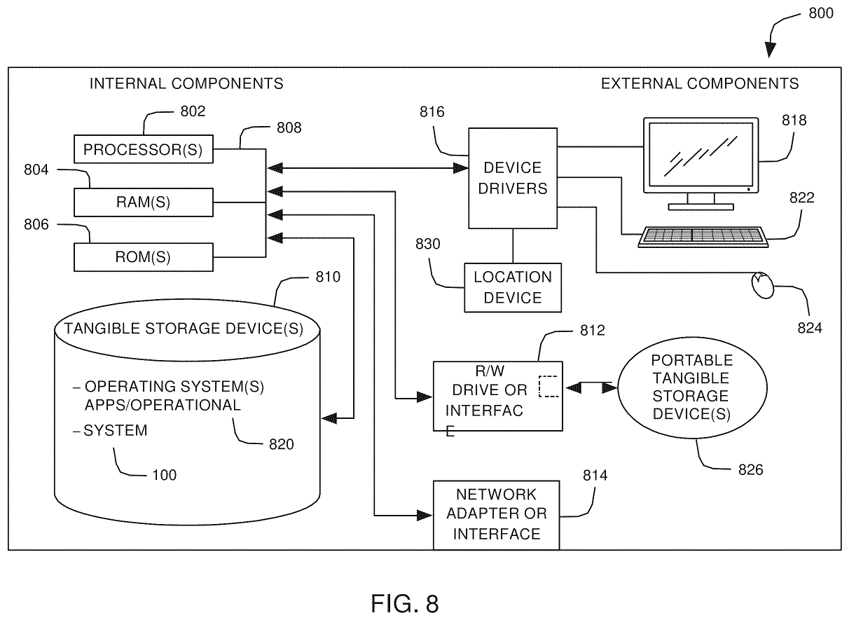

Lastly, the system includes robust plagiarism detection capabilities focused on information representation. It identifies and flags instances where unique representational elements, which are not industry standards, are replicated without authorization. This ensures the protection of proprietary information and maintains the integrity of original content, safeguarding intellectual property and promoting innovation. FIG. 8 is a block diagram of an embodiment of a computing device 800 in which the modules of the system of FIG. 8, described herein, are implemented.

The modules of the system 100 described herein are implemented in computing devices. The computing device 800 includes one or more processors 802, one or more computer-readable RAMs 804 and one or more computer-readable ROMs 806 on one or more buses 808. Further, computing device 400 includes a tangible storage device 810 that may be used to execute operating systems 820 and the system 100. The various modules of the system 100 may be stored in tangible storage device 810. Both the operating system 820 and the system 100 are executed by processor 802 via one or more respective RAMs 804 (which typically include cache memory). The execution of the operating system 820 and/or the system 100 by the processor 802, configures the processor 802 as a special purpose processor configured to carry out the functionalities of the operation system 820 and/or the system 100 as described above.

Examples of storage devices 810 include semiconductor storage devices such as ROM, EPROM, flash memory or any other computer-readable tangible storage device that may store a computer program and digital information.

Computing devices also include a R/W drive or interface 814 to read from and write to one or more portable computer-readable tangible storage devices 828 such as a CD-ROM, DVD, memory stick or semiconductor storage device. Further, network adapters or interfaces 812 such as a TCP/IP adapter cards, wireless Wi-Fi interface cards, or 3G or 4G wireless interface cards or other wired or wireless communication links are also included in computing device.

In one example embodiment, the system 100 may be stored in tangible storage device 810 and may be downloaded from an external computer via a network (for example, the Internet, a local area network or other, wide area network) and network adapter or interface 812.

Computing device further includes device drivers 816 to interface with input and output devices. The input and output devices may include a computer display monitor 818, a keyboard 824, a keypad, a touch screen, a computer mouse 826, and/or some other suitable input device.

The advantages of the present invention are a stable list of web landmarks are maintained. The disclosed method and system enhance the accuracy and efficiency of geolocation services. The disclosed system incorporates several innovative features, including an outlier detection mechanism utilizing latency data and density-based clustering to identify and eliminate landmarks with inaccurate metadata. Furthermore, the utilization of DBSCAN clustering efficiently groups landmarks within small areas, reducing redundancy and improving overall system efficiency. Time-series data collection and aggregation techniques with optimized storage and retrieval enable continuous assessment of landmark performance, surpassing conventional single-point measurements. Moreover, a weighted scoring system is introduced, evaluating landmarks based on multiple factors such as network latency, stability, reliability, and geographical diversity. Additionally, dynamic landmark density adjustment mechanisms, driven by a PID controller, optimize landmark distribution based on real-time performance and user demand. Network speed estimation techniques, including the Haversine formula and connection type classification, prioritize landmarks with faster and more reliable connections. An adaptive algorithm, utilizing reinforcement learning, dynamically adjusts landmark selection criteria based on region-specific challenges and historical performance data, ensuring optimal geolocation performance across diverse regions. Hence, the disclosed system and method provide responsiveness to regional differences, which are not provided by existing state of art technologies.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood, that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure. The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other examples features of example embodiments may be embodied in the form of an apparatus, method, system, computer program, tangible computer readable medium and tangible computer program product. For example, the aforementioned methods may be embodied in the form of a system or device, including, but not limited to, any of the structures for performing the methodology illustrated in the drawings.

In this application, including the definitions below, the term ‘module’ or the term [90]‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer-device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device's main body or a removable medium arranged so that it may be separated from the computer device's main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include, but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

What is claimed is:

1. A system to identify a content of interest from a corpus of documents, the system comprising:
an input module configured to:
obtain the corpus of documents, wherein each document contains the content of interest; and
receive a plurality of training documents, wherein each training document includes content tagged into a plurality of field elements, wherein one field element is the content of interest;
a training module coupled to the input module and configured to:
select a context window surrounding a field element in a training document based on a plurality of parameters defined for the field element, and by applying a context window identification model to the training document;
estimate for each data element present within the context window of the training document a weighted distance of the each data element from the field element, wherein the weighted distance and a position of the each data element with respect to the field element, is used to create a feature vector; and
provide a set of feature vectors developed for the plurality of field elements across the plurality of training documents as an input, to train a field element identification model; and
a prediction module coupled to the training module and configured to:
apply the context window identification model to the each document to identify one or more candidate context windows that contain the content of interest;
and
identify a beginning position of the content of interest within a candidate context window by applying the field element identification model on the one or more candidate context windows, wherein the beginning position is used to retrieve the content of interest from the each document.

2. The system of claim 1, wherein the training module is further configured to:
scan through each page of the training document for determining a frequency of occurrence of each data element and one or more zones in which the each data element occurs within the training document, wherein each page of the training document is sectioned into a plurality of zones;
identify one or more generic and domain specific patterns in the training document; and replace each of the one or more generic and domain specific patterns with a unique replacement element;
eliminate one or more predefined data elements from the training document; wherein a predefined data element is one of a pronoun, a proposition, a conjunction, a data element identified as least relevant in retrieval of the content of interest and a combination thereof;
eliminate one or more data elements having a frequency of occurrence lesser than a threshold value from the training document;
develop a feature matrix comprising a frequency of occurrence of each remaining data element in each zone of the training document; and
provide the feature matrix as an input to train the context window identification model, wherein the context window identification model is used to select the context window for the field element.

3. The system of claim 1, wherein the plurality of parameters comprises parameters defined for a data type associated with each field element, text alignment of the field element, text spacing within the field element, fonts of the field element, location parameters and context window parameters defined for the each field element.

4. The system of claim 1, wherein the training module is further configured to:
identify one or more generic and domain specific patterns in the training document;
replace each of the one or more generic and domain specific patterns with a unique replacement element; and
eliminate a predefined element from the training; document, wherein a predefined element is one or more of a pronoun, a proposition, a conjunction, a data element identified as least relevant in retrieval of the content of interest and a combination thereof.

5. The system of claim 1, wherein the weighted distance of the each data element from the content of interest is computed by determining a distance and direction along a horizontal and a vertical axis of the each data element from the content of interest and applying a weight factor associated with each direction.

6. The system of claim 5, further comprising a validation module coupled to the training module, wherein the validation module is configured to:
validate the retrieved content of interest based on the plurality of parameters defined for the field element; and
provide the content of interest on a user interface.

7. The system of claim 6, wherein the validation module is further configured to:
determine a difference between the content of interest and the retrieved content of interest, when the retrieved content of interest fails to validate;
adjusts the plurality of parameters, and the weight factor associated with the each direction based on the difference determined between the content of interest and the retrieved content of interest; and
retrain the context window identification model and the field element identification model on the document with the adjusted plurality of parameters and the weight factor associated with the each direction.

8. A computer-implemented method for identifying a content of interest in a document, the method comprising:
obtaining the document containing the content of interest;
receiving a plurality of training documents, wherein each training document includes one or more textual and image content that comprises a plurality of field elements, wherein one field element is the content of interest;
selecting a context window surrounding a field element in a training document based on a plurality of parameters defined for the field element, and by applying a context window identification model to the training document;
estimating for each data element present within the context window of the training document a weighted distance of the each data element from the field element, wherein the weighted distance and a position of the each data element with respect to the field element is used to create a feature vector;
providing a set of feature vectors developed for the plurality of field elements across the plurality of training documents as an input, in training a field element identification model;
applying the context window identification model to the document to identify one or more candidate context windows that contain the content of interest; and
applying the field element identification model on the one or more candidate context windows to identify a beginning position of the content of interest within a candidate context window.

9. The method of claim 8, wherein selecting the context window for the field element further comprises:
scanning each page of the training document for determining a frequency of occurrence of each data element and one or more zones in which the each data element occurs within the training document, wherein each page of the training document is sectioned into a plurality of zones;
identifying one or more generic and domain specific patterns in the training document;
replacing each of the one or more generic and domain specific patterns with a unique replacement element;
eliminating one or more predefined data elements from the training document; wherein a predefined data element is one or more of a pronoun, a proposition, a conjunction, a data element identified as least relevant in retrieval of the content of interest and a combination thereof;
eliminating data elements having a frequency of occurrence lesser than a threshold value from the training document;
developing a feature matrix comprising a frequency of occurrence of each remaining data element in each zone of the training document; and
training the context window identification model based on the feature matrix, wherein the context window identification model is used to select the context window for the field element.

10. The method of claim 8, the plurality of parameters comprises parameters defined for a data type associated with each field element, text alignment of the field element, text spacing within the field element, fonts of the field element, location parameters and context window parameters defined for the each field element.

11. The method of claim 8, further comprising:
identifying one or more generic and domain specific patterns in the training document;
replacing each of the one or more generic and domain specific patterns with a unique replacement element; and
eliminating a predefined element from the training; document, wherein a predefined element is one or more of a pronoun, a proposition, a conjunction, a data element identified as least relevant in retrieval of the content of interest and a combination thereof.

12. The method of claim 8, wherein the weighted distance of each data element from the content of interest is computed by determining a distance and direction along a horizontal and vertical axis of the each data element from the content of interest and applying a weight factor associated with each direction.

13. The method of claim 12, further comprises:
validating the identified content of interest based on the plurality of parameters defined for the field element.

14. The method of claim 13, further comprising:
determining a difference between the content of interest and the retrieved content of interest, when the retrieved content of interest fails to validate;
adjusting the plurality of parameters, and the weight factor associated with the each direction based on the difference determined between the content of interest and the retrieved content of interest; and
retraining the context window identification model and the field element identification model on the document with the adjusted plurality of parameters and the weight factor associated with the each direction.

15. A computer-implemented method for identifying a content of interest in a document, the method comprising:
obtaining the document containing the content of interest;
receiving a plurality of training documents, wherein each training document includes one or more textual and image content that comprises a plurality of field elements, wherein one field element corresponds to the content of interest;
estimating for each data element present within the training document a weighted distance of the each data element from the field element, wherein the weighted distance and a position of the each data element with respect to the field element is used to create a feature vector;
providing a set of feature vectors developed for the plurality of field elements across the plurality of training documents as an input, in training a field element identification model; and
identifying a beginning position of the content of interest by applying the field element identification model on the document.

16. The method of claim 15, the plurality of parameters comprises parameters defined for a data type associated with each field element, text alignment of the field element, text spacing within the field element, fonts of the field element, and location parameters defined for the each field element.

17. The method of claim 15, further comprising:
identifying one or more generic and domain specific patterns in the training document;
replacing each of the one or more generic and domain specific patterns with a unique replacement element; and
eliminating a predefined element from the training; document, wherein a predefined element is one or more of a pronoun, a proposition, a conjunction, a data element identified as least relevant in retrieval of the content of interest and a combination thereof.

18. The method of claim 15, wherein the weighted distance of each data element from the content of interest is computed by determining a distance and direction along a horizontal and vertical axis of the each data element from the content of interest and applying a weight factor that could be a linear, polynomial or exponential, function associated with each direction.

19. The method of claim 18, further comprises:
validating the identified content of interest based on the plurality of parameters defined for the field element.

20. The method of claim 19, further comprising:
determining a difference between the content of interest and the identified content of interest, when the identified content of interest fails to validate;
redefining the plurality of parameters, and one or more weights associated to a direction along an axis, wherein the weights are used for estimating a weighted distance of a data element around the content of interest; and
retraining the context window identification model and the field element identification model on the document with the redefined plurality of parameters and the one or more weights.
